(19) United States
(12) Patent Application Publication
(10) Pub. No.: US 2017/0068214 A1
(43) Pub. Date: Mar. 9, 2017

(54) PLASMONIC MULTICOLOR META-HOLOGRAM

(71) Applicant: Academia Sinica, Taipei City (TW)

(72) Inventors: DIN-PING TSAI, Taipei City (TW); YAO-WEI HUANG, Taipei City (TW); WEI-TING CHEN, Taipei City (TW); CHIH-MING WANG, Taipei City (TW)

(73) Assignee: Academia Sinica, Taipei City (TW)

(21) Appl. No.: 14/969,447

(22) Filed: Dec. 15, 2015

(30) Foreign Application Priority Data
Sep. 9, 2015 (TW) 104129747

(51) Int. Cl. G03H 1/22; G02F 1/00; G03H 1/02; G03H 1/26; G02B 1/00; G02B 5/00

(52) U.S. Cl. CPC G03H 1/2294; G02B 1/002; G02B 5/008; G03H 1/0272; G03H 1/2249; G03H 1/2645; G02F 1/0063; Y10S 977/834; B82Y 20/00

(57) ABSTRACT

A phase-modulated optical component for the visible spectrum is provided and is capable of producing images in three primary colors. The phase-modulated optical component is primarily structured by a plurality of aluminum nanorods that are arranged in several two-dimensional arrays to form a plurality of pixels. The nanorods can yield surface plasmon resonances in red, green and blue light. By tuning the nanorod size in the arrays, the wavelength-dependent reflectance thereof can be varied across the visible spectrum, thereby realizing wavelength division multiplexing operations for the phase-modulated optical component.

### BACKGROUND OF THE INVENTION

Field of the Invention

The present invention relates to an optical component, and more particularly, to a phase-modulated optical component based on a nanoplasmonic structure.

Description of the Prior Art

Optical components made of plasmonic metamaterials relate to the technical fields of nanomaterials and nanophotonics. Basically, a plasmonic metamaterial utilizes the anomalous optical phenomenon which is generated when resonance occurs for the electrons in a metal nanostructure. Particular applications of plasmonic metamaterials include realizations of, for example, negative index materials, superlenses, phase modulation, holograms, etc.

For example, plasmonic metasurfaces utilize custom sub-wavelength nanostructures on metasurfaces to modulate the phase of incident light (i.e., the electromagnetic wave), so that wavefronts of electromagnetic waves can be altered.

For further example, a published article (D. P. Tsai et al, “High-Efficiency Broadband Anomalous Reflection by Gradient Meta-Surfaces,” Nano Letters, 2012) disclosed an example of a phase-modulated optical component consisting of a gold nanostructure, MgF₂ and a gold-mirror. This optical component is capable of achieving phase modulation to a large extent for operating wavelengths in the near-infrared. However, it does not perform so well for resonances with other wavelengths, and cannot achieve wavelength division multiplexing nor display in three primary colors.

### SUMMARY OF THE INVENTION

To enable optical components based on nanoplasmonic structures to be further applied to applications with shorter wavelengths and achieve display in three primary colors, an object of the present invention is to provide an optical component including: a dielectric layer and a primary nanorod array formed thereon. The primary nanorod array is formed on the dielectric layer to define a pixel, and is composed of a plurality of nanorod sub-arrays arranged in two-dimensional arrays. Each nanorod sub-array is composed of a plurality of nanorods arranged in two-dimensional arrays, and the nanorods within a same nanorod sub-array are rectangular rods of the same shape. Each nanorod has a width and a length, and the length direction serves as the direction of that nanorod. All the nanorods within a single nanorod sub-array have the same length and are of the same direction. Moreover, among the plurality of nanorod sub-arrays which belong to a single pixel, at least three nanorod sub-arrays are composed of nanorods having different lengths. The single pixel includes at least two nanorod sub-arrays along a width direction thereof, and at least two nanorod sub-arrays along a length direction thereof. The nanorods are made of metal which has a relatively higher plasma resonance, so that a broader operating wavelength range can be achieved to cover shorter wavelengths of the spectrum.

The present invention further provides a display apparatus based on the aforementioned optical component. The display apparatus according to the present invention includes a light source and the aforementioned optical component. The light source emits polarized light to the optical component, which projects an image in response to the incident polarized light. The pattern of the image is relevant to the arrangement of the pixels, and the colors of the image are determined by the light source and the lengths of the nanorods within the nanorod sub-arrays of the pixels.

These and other features and advantages will be more apparent from the following detailed description of the embodiments and the appended claims.

### BRIEF DESCRIPTION OF THE DRAWINGS

The patent or application file contains at least one color drawing. Copies of this patent or patent application publication with color drawing will be provided by the USPTO upon request and payment of the necessary fee.

FIG. 1 illustrates schematics used to derive the generalized Snell's law.

FIG. 2 shows an exemplary resonant unit of a nanoscale optical component according to the present invention.

FIG. 3A is a schematic view showing a primary nanorod array and nanorod sub-arrays of the nanoscale optical component according to the present invention.

FIG. 3B is an SEM image of a surface array of the nanoscale optical component composed of the resonant units shown in FIG. 2, and A represents a side length of a pixel.

FIGS. 4(a) to 4(c) illustrate reflectance and phase distribution of the nanoscale optical component according to the invention, both of which vary in accordance with the nanorod lengths (L) and the wavelengths.

FIG. 5 is a schematic view showing an image reconstruction system used to reconstruct images recorded with the nanoscale optical component according to the invention.

FIGS. 6(a) to 6(c) illustrate a series of reconstructed images based on the nanoscale optical component according to the invention; the images are reconstructed by y-polarized light beams (including beams from red, green and blue light sources).

FIGS. 6(d) to 6(f) illustrate a series of reconstructed images based on the nanoscale optical component according to the invention; the images are reconstructed by y-polarized, 45°-polarized and x-polarized light beams respectively.

FIGS. 7(a) to 7(c) illustrate relations between reflectance and nanorod length over various operating wavelengths with respect to the nanoscale optical component according to the invention, as well as the reflective images in SEM images.

### DETAILED DESCRIPTION OF THE PREFERRED EMBODIMENTS

The nanoscale optical component exemplified in the present invention is a type of metasurface. In general, such metasurface has a plurality of metal nanostructures periodically arranged thereon, and the design and arrangement of those metal nanostructures are mostly related to phase modulation for electromagnetic waves. When an incident electromagnetic wave arrives at the metasurface, the metal nanostructure thereof is then excited and a plasmon resonance occurs, which causes the metal nanostructure to further radiate an electromagnetic wave. Compared to the incident wave, the radiated electromagnetic wave from the excited metal nanostructure has been altered in intensity and phase and is propagating in accordance with the generalized Snell's Law.

Generalized Snell's Law

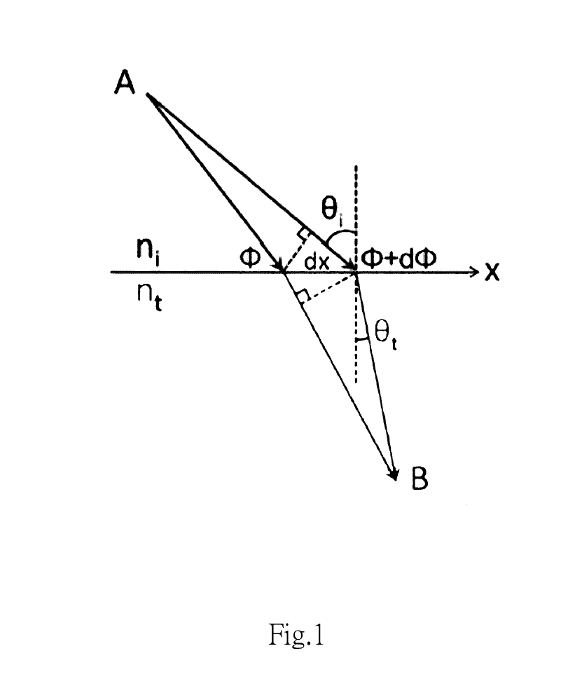

With reference to FIG. 1, as far as a metasurface is concerned, an artificial structure (such as the metal nanostructure according to the present invention) configured on an interface defined between two mediums is capable of providing phase modulation for electromagnetic waves. Assuming that two incident rays arriving at the interface with phase shift are respectively denoted as Φ and Φ+dΦ, wherein Φ represents a function of position x, the incident ray propagated from position A to position B can be presented as the following equation:

$$[ {k}_{0} {n}_{i} sin {θ}_{i} d x + ( Φ + d Φ ) ] - [ {k}_{0} {n}_{t} sin {θ}_{t} + Φ ] = 0 \\ ⇒ sin ( {θ}_{t} ) {n}_{t} - sin ( {θ}_{i} ) {n}_{i} = ( \frac{{λ}_{0}}{2 π} ) \frac{d Φ}{d x} , \qquad ( 1 )$$

where θᵢ and θᵢ respectively denote the angle of refraction and the angle of reflection, while nₜ and nᵢ respectively denote the index of refraction in the incident medium and the index of refraction in the refracting medium.

Similarly with Eq. (1), under the same interface between the incident medium and the refracting medium, the incident ray, its relevant reflection ray (with an angle of reflection θᵣ) and their relation can be presented as the following equation:

$$sin ( {θ}_{r} ) - sin ( {θ}_{i} ) = ( \frac{{λ}_{0}}{2 π {n}_{i}} ) \frac{d Φ}{d x} . \qquad ( 2 )$$

Eq. (2) can be further manipulated by multiplying a wave vector of incident wave, kᵢ, to both sides of the equation, such that Eq. (2) is then transferred into a relationship showing the wave vector conversation in the horizontal direction extending along the interface. The transferred equations are shown as below:

$$\begin{matrix}{k}_{r , x} = {k}_{i , x} + ξ & ( 3.1 ) \\ {k}_{i , x} = {k}_{i} sin {θ}_{i} & ( 3.2 ) \\ {k}_{r , x} = {k}_{i} sin {θ}_{r} & ( 3.3 ) \\ ξ = {n}_{i} ( \frac{d Φ}{d x} ) & ( 3.4 )\end{matrix}$$

where k_{r,x} denotes the horizontal momentum of the reflection ray along the X direction, k_{i,x} denotes the horizontal momentum of the incident ray along the X direction, and ξ denotes a value associated with the change rate of the phase and which is also associated with the distance change at the interface (i.e. dΦ/dx). In other words, according to Eqs. (3), if the change rate of the phase along a horizontal direction (e.g. X direction) is not zero at the interface between two heterogeneous mediums, the horizontal component of the wave vector of the reflection ray can be a sum of the horizontal component of the wave vector of the incident ray and the horizontal momentum associated with the interface structure. As a result, the incident angle does not equal the reflection angle, and anomalous reflection occurs.

However, for a metasurface, both common reflection and anomalous reflection induced by an incident electromagnetic wave may occur simultaneously. In the following exemplified embodiments, unless otherwise indicated, the reflections as described all refer to anomalous reflections caused by the nanoscale optical component according to the invention.

Design of the Nanoscale Optical Component

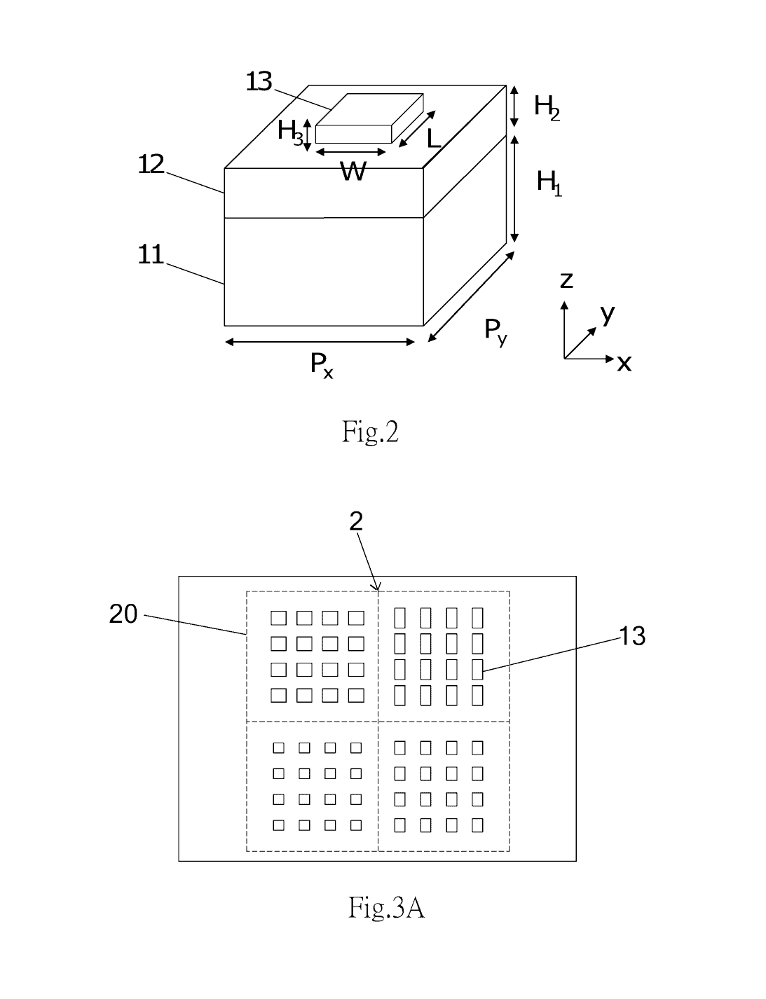

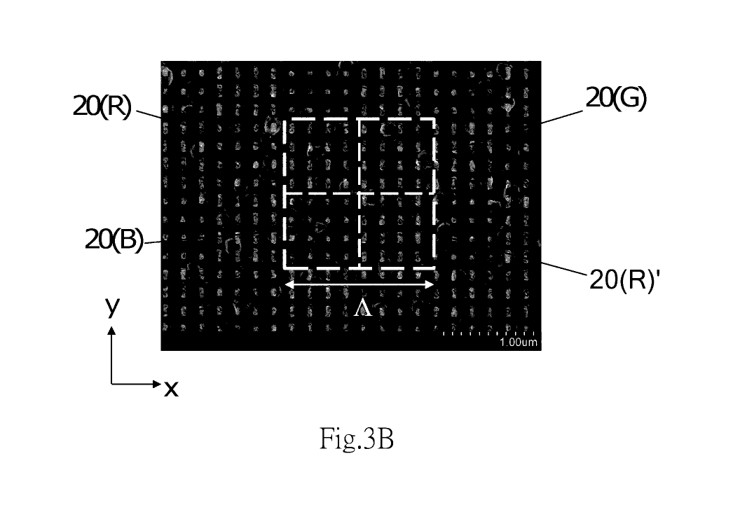

With references to FIG. 2 and FIGS. 3A to 3B, a nanoscale optical component according to one embodiment of the invention with its stacked structure and array arrangements are provided. FIG. 2 shows a smallest unit cell (hereafter referred to as a resonant unit) of the nanoscale optical component according to the invention that is able to induce plasmon resonance. The resonant unit is stacked with layers including a metal layer 11, a dielectric layer 12 and a nanorod 13. The metal layer 11 is defined by a layer with an even thickness H₁, and one surface of the metal layer 11 serves as a reflection surface of said optical component. In general, the thickness H₁ of the metal layer 11 is less than the wavelengths of visible region, preferably in a range from 100 nm to 200 nm, such as 130 nm. The metal layer 11 can be made of one or more metals depending on the desired operating wavelength(s) for the optical component, preferably metals or semiconductor materials having high plasma frequency, such as aluminum, silver or semiconductor materials with a permittivity less than zero.

The dielectric layer 12 is formed at one side of the metal layer 11. For example, the dielectric layer 12 can be formed on the reflection surface of the metal layer 11. The dielectric layer 12 is defined by a layer with an even thickness H₂, wherein the thickness H₂ is less than the wavelengths of visible region, preferably in a range of 5 nm to 100 nm, such as 30 nm. In general, the dielectric layer 12 is made of a material transparent to visible spectrumlight, and can be selected from a group consisting of insulators or semiconductor materials with a permittivity larger than zero, such as silicon (SiO₂), magnesium fluoride (MgF₂), aluminum oxide (Al₂O₃), hafnium oxide (HfO₂), etc. For semiconductor materials with a permittivity less than zero, their optical properties may resemble those of metals. For semiconductor materials with a permittivity larger than zero, their optical properties may resemble those of dielectrics. The dielectric layer 12 has a carrying surface which corresponds to the surface where the dielectric layer 12 and the metal layer 11 interface. As shown in FIG. 3, one or more nanorods can be formed on the carrying surface of the dielectric layer 12.

As can be seen in FIG. 2, the resonant unit has a length Pₓ extending along the x-direction and another length P_{y} extending along the y-direction, both of which define the horizontal dimensions of the resonant unit. In general, Pₓ and/or P_{y} may be less than twice the operating wavelength of the optical component. For example, Pₓ=P_{y}=200 nm. The nanorod 13 is defined by a length L, a width W and a thickness H₃, wherein the length L is substantially parallel to P_{y} but shorter than it, while the width W is substantially parallel to Px but shorter than it. Thus, the nanorod 13 occupies an area that is smaller than or does not exceed the area defined by Pₓ and P_{y}. Generally, L≧W>H₃. The thickness H₃ is less than the wavelengths of visible region, preferably in a range of 10 nm to 100 nm. For an exemplified nanorod in an embodiment, L can fall within a range of 50 nm to 180 nm, W can be 50 nm while H₃ can be 25 nm. As shown in FIG. 2, the nanorod 13 has a substantially rectangular shape whose length direction and width direction are significantly associated with the resonance direction induced by the incident electromagnetic wave. In some embodiments of the present invention, said nanorod 13 can be defined by other side lengths, such as a circumference together with a thickness. The nanorod 13 can be made of metal, such as aluminum, silver or gold, and/or semiconductor materials. In particular, if the nanorod 13 is made of aluminum, a broader range of the resonance spectrum covering the visible region (400 nm to 700 nm) or even the infrared and/or ultraviolet region can be obtained.

In some embodiments, the nanoscale optical component according to the present invention may include other layers in its structure, such as a substrate, or a buffer layer formed between a substrate and the metal layer 11. In general, the layer structure as described above can be fabricated with conventional approaches, such as e-beam lithography, nanoimprint lithography or ion beam milling, and thus the description thereof is omitted for brevity.

Referring to FIG. 3A, the optical component according to the present invention includes an array structure which is composed of a plurality of resonant units of FIG. 2. Said array structure includes a plurality of primary nanorod arrays 2 (only one shown in FIG. 3A), and each of the primary nanorod arrays 2 further includes several sub-arrays 20 (there are four shown in FIG. 3A). Each sub-array 20 contains an array of identical nanorods 13. That is, all of the nanorods 13 within the sub-array 20 have the same length L and are arranged periodically along both the x-direction and the y-direction. For example, a two-dimensional 4×4 nanorod array is shown in each sub-array 20. The side length of each sub-array 20 can be the sum of the side lengths (Pₓ, P_{y}) of the resonant units defining the sub-array 20. For example, if Pₓ=200 nm, the side length of the sub-array for the 4×4 nanorod array can be 800 nm. The nanorods 13 contained in the sub-array 20 are generally oriented in the same direction, which enables the sub-array 20 to achieve specific resonance effect in a particular direction, and thereby to achieve modulation of reflectance and phase for the incident wave. The relation between the nanorod length L and the operating wavelengths, in particular with repect to the reflectance and phase modulation, will be described later in the paragraphs below.

The nanoscale optical component according to the present invention includes a plurality of pixels, each pixel is defined by a primary nanorod array 2. The pixels are associated with one or more patterns recorded in the optical component. Each pixel is defined by the primary nanorod array 2 composed of a plurality of sub-arrays 20. The pixel may include at least three nanorod sub-arrays, each of which has a specific nanorod length different from that of another sub-array. As can be seen in FIG. 3A, in the 22 sub-arrays, any three of the sub-arrays have three respective nanorod lengths. The nanorods 13 are disposed on a part of a peripheral surface of the optical component, arranged periodically along the x-direction and the y-direction. On a peripheral surface of the optical component, there may be several rows and columns of nanorods 13 arranged in one or more arrays. The optical component may comprise or may be composed of several rows and columns of resonant units. All of the nanorods 13 contained in the sub-arrays have substantially the same width W and thickness H₃, and each nanorod 13 is located in a respective area of the resonant unit (i.e. defined by Pₓ and P_{y}). Two adjacent nanorods in the x-direction have a spacing which equals Px, and thus the nanorods along the x-direction are arranged periodically over the sub-arrays 20. The primary array 2 may include nanorods with at least two different lengths L in the respective sub-arrays 20.

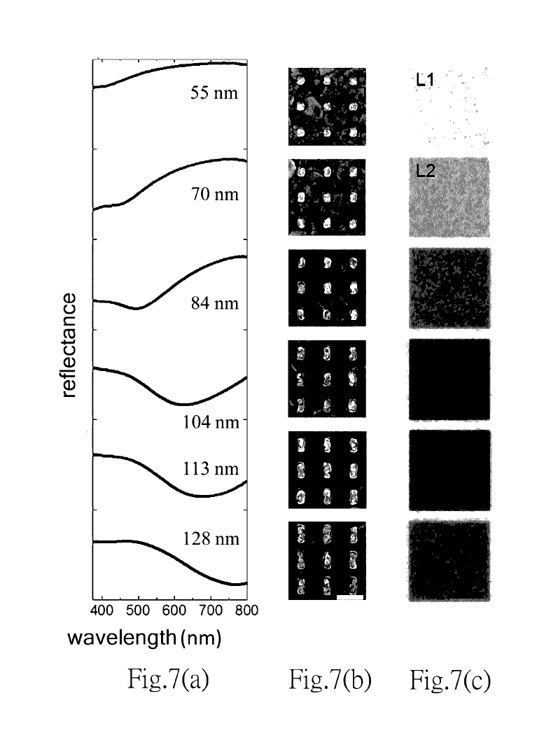

FIG. 3B is an SEM image with a scale bar of 1 μm, showing a partial top view of some nanorod arrays of the optical component according to the present invention. As can be seen in FIG. 3B, a pixel may be composed of 2×2 adjoining sub-arrays 20(R), 20(G), 20(B) and 20(R)′. That is, the pixel has at least two sub-arrays along the direction of the nanorod width and at least two sub-arrays along the direction of the nanorod length. Although other embodiments for the pixel are absent from the drawing, the pixel may be composed in several possible ways of permutation, such as in 2×3 or 3×4 arrangements. These sub-arrays 20(R), 20(G), 20(B) and 20(R)′ can be divided into red sub-arrays 20(R) and 20 (R)′, a blue sub-array 20(B) and a green sub-array 20(G) according to their optical properties (i.e. plasmon resonance properties). For the red sub-arrays 20(R) and 20(R)′, the nanorods contained in the two respective sub-arrays may have the same nanorod length. This is to ensure a sufficient red light reflection which is generally weaker than the reflection of the blue and green sub-arrays. One or more operating wavelengths for each sub-array can be defined by the spectrum distribution associated with the sub-array, which can be seen in FIG. 7 and described later in the paragraphs below.

As shown in FIG. 3B, the pixel occupies an area defined by Λ×Λ (1600×1600 nm²) that is composed of 2×2 sub-arrays 20(R), 20(G), 20(B) and 20(R)′, wherein each sub-array is further composed of a 4×4 array of nanorods. In some embodiments of the present invention, the pixel can be composed of more sub-arrays having more than three different nanorod lengths set in the respective nanorod sub-arrays.

In some embodiments, the optical component according to the present invention may include several red sub-arrays, green sub-arrays and blue sub-arrays depending on the optical properties or resonance performance of the sub-arrays contained in the optical component. In other embodiments, the red sub-arrays of the optical component may have two different nanorod lengths constituting different red sub-arrays, such as the red sub-arrays 20(R) and 20(R)′ shown in FIG. 3B. Similarly, it is possible to design the green sub-arrays and/or the blue sub-arrays with different nanorod lengths. In this way, the nanoscale optical component according to the present invention is able to implement two-level phase modulation for an incident wave. As such, with a monochromatic operating wavelength, the two-level optical component according to the present invention is able to provide two different resonant modes that may produce two reflections for an incident wave. In the case that the three primary colors (RGB) are used as the operating wavelengths, the nanoscale optical component may provide six different resonant modes.

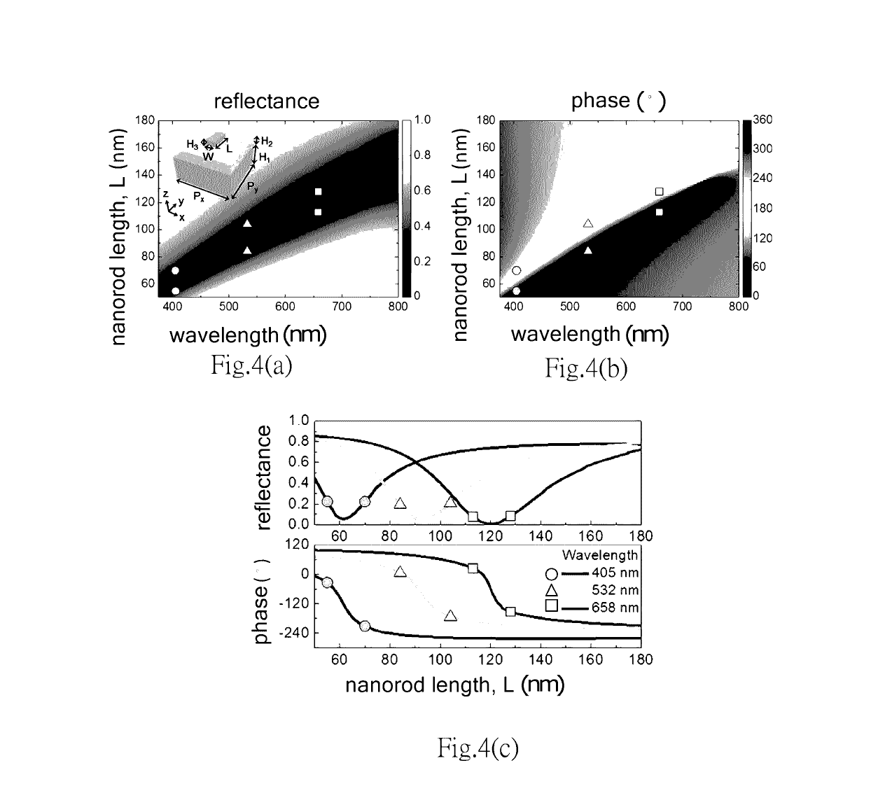

With reference to FIGS. 4(a) and 4(b), a reflectance and phase distribution as a function of wavelength and length L of nanorod are illustrated (H₁, H₂, H₃ and W are fixed values here). As can be seen in the figures, the resonance spectral range may be from 375 nm to 800 nm. The value of reflectance is associated with the amplitude of the reflection wave, and the amount of phase is associated with the reflection angle of the reflection wave (i.e. θᵣ, as presented in Eq. (2)), since any phase shift or delay will influence the wavefront's propagation across the nanoscale structure. According to the reflection spectrum and phase distribution, a desired reflectance and phase control for each resonant unit of the nanoscale optical component according to the present invention can be determined by the nanorod length L thereof. For example, as shown in FIGS. 4(a) and 4(b), each single point marked in the distribution, such as the blue circle, green triangle and red square, represents a type of the resonant unit that constitutes the nanoscale optical component according to the present invention.

For example, the two blue circles refer respectively to the nanorod lengths of 55 nm and 70 nm, and with such configuration their resonant units or sub-arrays constituted respectively may produce a phase shift of π therebetween, for a specific operating wavelength in the blue region. Also, similar effect may occur as indicated by the green triangles with the respective nanorod lengths of 84 nm and 104 nm, or as indicated by the red squares with the respective nanorod lengths of 113 nm and 128 nm. With this design, the nanoscale optical component can provide six resonant modes. However, depending on the selection of nanorod lengths, the nanoscale optical component according to the present invention can provide more resonant modes. Furthermore, the nanorods may be configured in multiple orientations. For example, referring back to FIG. 3, the nanorods contained in one part of the sub-arrays may have their nanorod length L extending along the x-direction, while the nanorods contained in another part of the sub-arrays have their nanorod length L extending along the y-direction. For another example, two arrays of nanorods contained in two respective sub-arrays may form an angle with respect to each other. As such, the nanoscale optical component according to the present invention is able to produce resonance in more directions with the foregoing configuration.

With reference to FIG. 4(c), relations concerning the reflectance and phase versus nanorod length are shown, with the operating wavelengths fixed at 405 nm, 532 nm and 658 nm. As indicated in the figure, the lowest reflectance for the wavelength of 405 nm occurs when the nanorod length is set to a range from 55 nm to 70 nm; the lowest reflectance for the wavelength of 532 nm occurs when the nanorod length is set to a range from 84 nm to 104 nm; the lowest reflectance for the wavelength of 658 nm occurs when the nanorod length is set to a range from 113 nm to 128 nm.

It can be understood from FIG. 4 that, the optical reflection and phase shift over the visible spectrum for each resonant unit or sub-array are varied nonlinearly depending on the nanorod length thereof. Such nonlinear variations can be determined based at least on the size of nanorods, the orientation of nanorod arrays and/or the selection of the dielectric layer and the metal layer.

To be specific, the nanoscale optical component according to the present invention can be a reflection mirror having a metasurface. The storage of patterns may be established by using several pixels composed of different nanorod sub-arrays to form the pattern.

Image Reconstruction

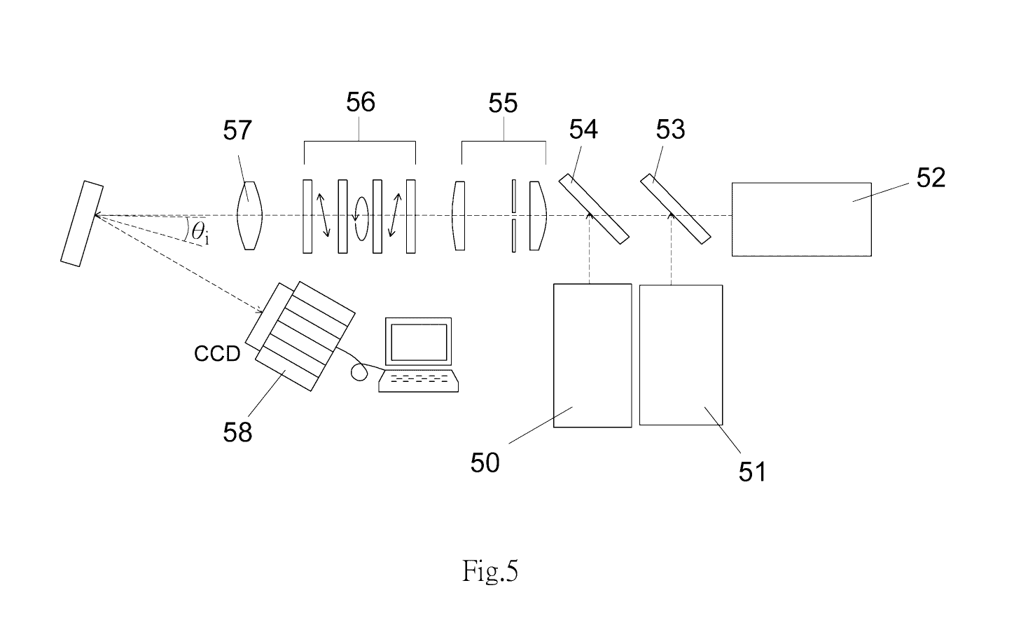

FIG. 5 illustrates an exemplary image reconstruction system which is utilized to reconstruct one or more images recorded in the nanoscale optical component according to the present invention. The system utilizes three laser diodes 50, 51 and 52 to generate respective laser beams at the wavelengths of 405 nm, 532 nm and 658 nm as the operating wavelengths for reconstructing the one or more images. The beams are combined as one major after successively passing through a first dichromic mirror 53 and a second dichromic mirror 54. A beam adjusting component 55 including at least two lenses and a pin hole is configured to adjust the spot size of the major beam. A polarization modulating component 56 including one or more polarizers, quarter-wave plates and filters is configured to control polarization of the major beam. The polarized beam is then focused on a focal plane by a focal lens 57. The nanoscale optical component according to the present invention is placed at the focal plane of the focal lens 57, where a part of the metasurface of the nanoscale optical component overlaps with the focal plane to receive the polarized and focused beam. The incident beam is then reflected from the metasurface with modulated phase and recorded by a CCD camera 58 for further processing.

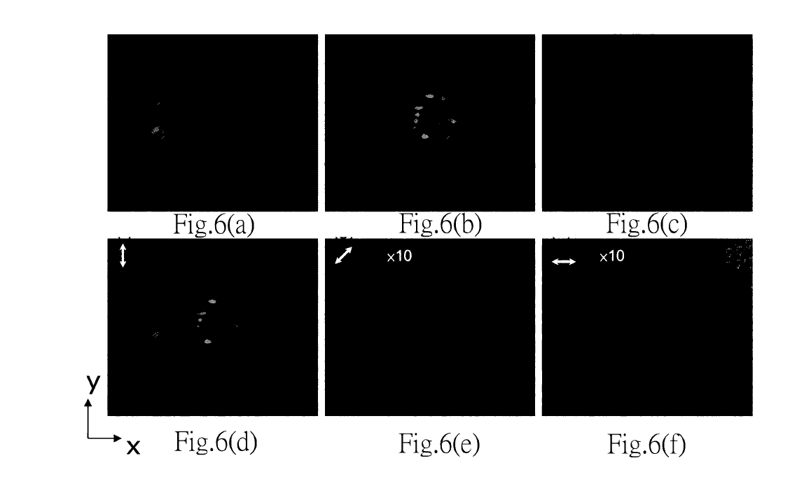

FIGS. 6(a) to 6(c) exemplify a series of reconstructed images based on the foregoing system and the configuration shown in FIG. 3B at y-polarized operating wavelengths of 405 nm, 532 nm and 658 nm respectively. The different groups of sub-arrays with specific operating wavelength or spectrum (such as 20(R), 20(G), and 20(B) shown in FIG. 3B) produce one or more RGB images respectively in response to their corresponding incident wavelength, and the patterns of these reconstructed images are associated with the arrangement of the pixels.

FIGS. 6(d) to 6(f) exemplify a series of reconstructed images based on the foregoing system and the configuration shown in FIG. 3B using y-polarized, 45°-polarized and x-polarized three-color laser beams respectively. As can be seen, the reconstructed image gradually disappears when the operating laser beam turns from y-polarization to x-polarization. The polarization direction of the incident beam for image reconstruction can be determined by the direction of the nanorod length L in the optical component.

Aluminum Nanorods Versus Reflectance Spectra

According to the foregoing description, aluminum nanorods constituting the metasurface according to the present invention can expand the resonance spectral range to 375 nm, allowing for applications in the visible spectrum. In addition, the reflectance spectrum can be determined by the nanorod size, particularly by the nanorod length L.

FIGS. 7(a) and 7(c) show the different nanorod arrays contained in the optical component and their optical properties. FIG. 7(b) shows a series of SEM images of part of the nanorod sub-arrays in six sizes. These nanorod sub-arrays are formed based on a silicon layer (the dielectric layer) with a thickness of 30 nm and an aluminum layer (the metal layer) with a thickness of 130 nm. These SEM images are shown with a 200 nm scale bar and include images of nanorod sub-arrays, from top to the bottom, having rod lengths L₁=55 nm, L₂=70 nm, L₃=84 nm, L₄=104 nm, L₅=113 nm and L₅=126 nm, which respectively correspond to the reflectance spectra shown in FIG. 7(a) and reflection images shown in FIG. 7(c). FIG. 7(c), where a scale bar of 20 μm is included, shows reflective images of the optical component based on the nanorod sub-arrays shown in FIG. 7(b).

As can be seen in the figure, each of the reflectance spectra of visible light has a valley point (associated with the resonance) which shifts toward longer wavelength as its rod length increases, resulting in reflective color changes from yellow through orange and blue to cyan corresponding to the complementary colors of each plasmonic band. In other words, the reflective color of the nanorod sub-array (such as the sub-array 20) can be determined by the nanorod length. For example, but it should not be construed as limiting the scope of the invention, the reflective color of nanorod sub-arrays change from yellow through orange when the rod length L is set to a range of 55-84 nm (including 55-70 nm and 70-84 nm); the reflective color of nanorod sub-arrays changes from blue through cyan when the rod length L is set to a range of 104-128 nm (including 104-113 nm and 113-128 nm).Although it is not disclosed in the drawings, those having ordinary knowledge in the art should understand that the nanorod width, thickness or density of nanorods in the sub-array may also influence the reflectance spectrum for the optical component according to the present invention. Also, the rod length and its corresponding reflective color disclosed herein are not meant to limit the scope of the invention. Even in other embodiments that the nanorods have the same length in different sub-arrays, the sub-arrays may appear various shifts in resonance spectra according to various array arrangements or selection of materials.

The nanoscale optical component according to the present invention employs aluminum nanorods having higher plasma frequency to yield plasmon resonances across a broader range of the spectrum which even includes the blue light range, meaning that applications of the nanoscale optical component can be expanded. In addition, the nanoscale optical component according to the present invention can be employed in hologram applications. A hologram can record one or more patterns therein. Each of the recorded patterns can be composed of several pixels that are constituted by several sub-arrays having various nanorod lengths L respectively adapted for specific operating wavelengths, so that image reconstruction with WDM (wavelength division multiplexing) operations can be realized. Based on different operating wavelengths of the beams reflected respectively with specific reflection angles, the one or more reconstructed images projected from the nanoscale optical component according to the invention can have patterns distributed in a particular manner. Accordingly, such optical component can be used to fabricate hologram security labels in full colors. And given that the feature of WDM operations can be realized, the nanoscale optical component according to the present invention can also be applied to display units to realize full-color display or full-color image projection, for example. Moreover, a hologram applying a nanoscale optical component according to the present invention can be a two-level hologram which requires two different nanorod lengths for a single color, and thereby a phase modulation can be achieved for the single color with a phase shift of π or 180 degrees. Likewise, a three-level hologram requires three different nanorod lengths for a single color and can achieve a phase modulation up to 2π/3 or 120 degrees, while a four-level hologram requires four nanorod lengths for a single color and can achieve a phase modulation up to π/2 or 90 degrees. Other changes or modifications to the phase levels of a hologram in connection with phase modulations can be derived with common knowledge in the art to which the invention pertains.

The foregoing embodiments and other embodiments would be obvious in view of the scope defined by following claims.

What is claimed is:

1. An optical component, comprising:
a dielectric layer; and
a primary nanorod array, formed on the dielectric layer and defining a pixel, the primary nanorod array being composed of a plurality of nanorod sub-arrays arranged in two dimensions;
wherein each of the plurality of nanorod sub-arrays is composed of nanorods arranged in a two-dimensional array, and said nanorods in each nanorod sub-array are identical rods having the same rectangular shape, and
wherein the nanorods in at least three of the plurality of nanorod sub-arrays have different rod lengths.

2. The optical component of claim 1, wherein the nanorods are made of metal.

3. The optical component of claim 2, wherein the nanorods are made of aluminum, silver, gold or a semiconductor material.

4. The optical component of claim 1, further comprising a metal layer on which the dielectric layer is formed.

5. The optical component of claim 4, wherein the metal layer is made of aluminum.

6. The optical component of claim 1, wherein the dielectric layer is made of silicon, magnesium fluoride, aluminum oxide or hafnium oxide.

7. The optical component of claim 1, wherein the amount of the plurality of nanorod sub-arrays constituting the primary nanorod array is four.

8. The optical component of claim 1, wherein an operating wavelength for each of the plurality of nanorod sub-arrays is determined by the rod length of the nanorods contained said nanorod sub-array.

9. A display apparatus, comprising:
an optical component, comprising
a dielectric layer; and
a plurality of primary nanorod arrays, formed on the dielectric layer and defining a plurality of pixels, each pixel being composed of a plurality of nanorod sub-arrays arranged in two dimensions;
wherein each of the plurality of nanorod sub-arrays is composed of nanorods arranged in a two-dimensional array, and said nanorods in each nanorod sub-array are identical rods having the same rectangular shape, and
wherein the nanorods in at least three of the plurality of nanorod sub-arrays have different rod lengths; and
a light source, configured to project polarized light onto the optical component,
wherein the optical component projects one or more images in response to the polarized light incident on the optical component, a pattern of the image is associated with an arrangement of the plurality of the pixels, and a color of the image is determined based on the light source used and the rod lengths of the nanorods contained in the plurality of nanorod sub-arrays.

10. The display apparatus of claim 9, wherein the light source generates red light, green light or blue light or a combination thereof.
